(19) United States
(12) Patent Application Publication
(10) Pub. No.: US 2020/0210809 A1
(43) Pub. Date: Jul. 2, 2020

(54) SYSTEM AND METHOD FOR OUTLIER DETECTION USING A CASCADE OF NEURAL NETWORKS

(71) Applicant: Playtika Ltd., Hertsliya (IL)

(72) Inventors: Idan KAIZERMAN, Meitar (IL); Assaf Asbag, Alfei Menashe (IL)

(73) Assignee: Playtika Ltd., Hertsliya (IL)

(21) Appl. No.: 16/236,541

(22) Filed: Dec. 30, 2018

(51) Int. Cl. G06N 3/04; G06N 3/08

(52) U.S. Cl. CPC G06N 3/0454; G06N 3/084; G06N 3/0445; G06N 3/04

(57) ABSTRACT

A system and method for detecting anomalies in time series data of online games, including obtaining the time series data, wherein the time series data is related to events in online games; extracting features from the time series data; dividing the features into at least two subgroups of features; providing each of the subgroup of features as input to a dedicated neural network of a plurality of dedicated neural networks; providing outputs of each of the dedicated neural networks as input to an outlier detection neural network, wherein the dedicated neural network and the outlier detection neural network are trained to detect the anomalies in the time series data, and wherein the outlier detection neural network provides a classification of the time series data. The features may be divided based on a type of the features and/or based on a time window of the features.

### FIELD OF THE INVENTION

Embodiments of the invention relate to a technology for detecting outliers in a time series data using a cascade of neural networks, for example, for detecting fraudulent events or technical problems in online gaming patterns.

### BACKGROUND OF THE INVENTION

The online gaming industry is a billion dollars industry with companies that worth hundreds of millions of dollars, each operating tens of millions of users. The most significant challenge these companies face is frauds. Frauds not only cause enormous financial damage to gaming companies, but also damage their credibility. Creating and operating a massive multiplayer game hosting millions of online gamers is a challenging effort. Gaming companies expose themselves to many attacks and frauds. Fraud detection may include monitoring of spending and gaming patterns of players in order to detect undesirable behavior

Operating large scale online games require significant investment in information technology (IT) and operations. Maintaining a robust online gaming system requires fast response times. IT problems, also referred to herein as operational problems, such as server and storage downtime, network disconnections, etc., can significantly impact player experience and as a result game revenue. Additionally, various activities such as deployment of new software versions of client and servers and new game features occur very frequently. Any mistake carried over these activities can range from impacting player experience to loss of payments.

The players' experience today is not at its best. As a result of frauds, the game economy is being compromised, the potential for players to progress in the game is damaged, and developers are losing potential revenue on the one hand and have to compensate customers on the other. In addition, due to operation failures, the games are perceived as not 100% stable and suffer from malfunctions and failures more frequently than desired. Both fraud and IT problems may damage the user experience of the players by not allowing them to progress in the game, go through stages and get the bonuses they deserve, thus reducing user satisfaction. These problems may even cause players to abandon the game. Thus, there is a need to improve the user experience by reducing operational malfunctions and fraud to the point of preventing them altogether.

### SUMMARY

According to embodiments of the invention, there is provided a system and method for detecting anomalies in time series data of online games. Embodiments of the invention may include: obtaining the time series data, wherein the time series data is related to events for example in online games; extracting features from the time series data; dividing or segmenting the features into at least two subgroups of features; providing each of the subgroup of features as input to a dedicated neural network of a plurality of dedicated neural networks; providing outputs of each of the dedicated neural networks as input to an outlier detection neural network, wherein the dedicated neural network and the outlier detection neural network are trained to detect the anomalies in the time series data, and wherein the outlier detection neural network provides a classification of the time series data.

Furthermore, according to embodiments of the invention, the features may be divided based on a type of the features and/or based on a time window of the features.

Furthermore, embodiments of the invention may include: providing real time data as input to a first dedicated neural network of the plurality of dedicated neural networks; providing features related to a time window of 1-2 days as input to a second dedicated neural network of the plurality of dedicated neural networks; and providing features related to a time window of 1-2 hours as input to a second dedicated neural network of the plurality of dedicated neural networks.

Furthermore, according to embodiments of the invention, the first dedicated neural network may be a deep neural network and the second and third dedicated neural networks may be one of a recurrent neural network and a long-short term memory network.

Furthermore, according to embodiments of the invention, the dedicated neural network and the outlier detection neural network are trained to detect the anomalies in the time series data using a labeled training set.

Furthermore, according to embodiments of the invention, the outlier detection neural network may provide a classification of the time series data to one of fraud, operational problem and normal behavior, and embodiments of the invention may further include reverting to a last known stable version of the software in case the classification is fraud.

According to embodiments of the invention, there is provided a system and method for detecting anomalies in time series data of online games. Embodiments of the invention may include: obtaining the time series data, wherein the time series data is related to events; extracting features from the time series data; dividing the features into subgroups of features; providing a first subgroup of features as input to a first neural network; providing a second subgroup of features as input to a second neural network, providing output of the first neural network and output of the second neural network as input to a third neural network, wherein the first neural network, the second neural network and the third neural network are trained to detect the anomalies in the time series data.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates a system, according to embodiments of the invention;

FIG. 2 is a flowchart of a method for detecting anomalies in gaming patterns using a cascade of neural networks, according to embodiments of the invention;

FIG. 3 depicts time series data of two example channels, helpful in demonstrating embodiments of the invention;

FIG. 4 depicts a block diagram of a cascade of neural networks, according to some embodiments of the invention; and

FIG. 5 is a high-level block diagram of an exemplary computing device, according to some embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well-known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the invention pertain, inter alia, to the technology of outlier detection in multidimensional time data series, and specifically, to the technology of outlier detection in the online gaming industry. Embodiments of the invention may significantly reduce operational costs and loss caused by frauds or operational mistakes, and enhance the players' gaming experience.

Embodiments of the invention may obtain a multi-channel time series data including or describing gaming activities of players. The time series data may include a list of values related to or describing events, software actions, or activities, and ordered according to the time occurrence. The time series data may include the time the events took place, or sample number, e.g., each sample may be paired with its time of occurrence or sample number, or may only be arranged ordered according to the time occurrence. The time series data may be arranged in channels according for example, to player identity number (ID) and data type. The time series data may be analyzed to provide an indication of outlier events or anomalies in the time series data. Embodiments of the invention may further analyze the origin or root cause of the outlier event or anomalies, e.g., whether an outlier event is a result of a fraud or a result of an IT or operational problem. Embodiments of the invention may automatically detect outliers on massive scale multi-channel data streams using machine learning (ML) and artificial intelligence (AI) models. Embodiments of the invention may maintain low false alarm rate, quick response time and high detection accuracy.

By detecting the source of outlier events, embodiments of the invention may help to overcome and prevent games operation failures and significantly reduce the possibility of fraud. As a result, embodiments of the invention may increase the reliability of the game technology, providing improvements over prior art online game technology for example by being more stable with less failures and malfunctions. Moreover, embodiments of the invention may reduce the damage to users because fraud may reduce the pool of benefits and bonuses that are divided to users. Thus, preventing and reducing fraud may improve the user experience.

Embodiments of the invention may utilize a cascade of neural network frameworks to extract features and decide whether an event in the time series data is an outlier or normal. As used herein a cascade of neural networks may include a plurality of neural networks arranged in layers where the outputs of a first layer are the input of the second layer, etc. Each of the neural networks in the cascade of neural networks may be of any type of neural network, including but not limited to, multilayer perceptrons (MLPs), deep neural networks (DNN), convolutional neural networks (CNNs), long short term memory networks (LSTM), recurrent neural networks (RNN), and any combination thereof. Each of the neural networks in the cascade of neural networks may be of the same type or of different types. For example, a first neural network in a first layer in the cascade may be a CNN, a second neural network in the first layer may be an LSTM and a neural network in second layer of the cascade (e.g., a neural network that received the outputs of the two neural networks of the first layer as inputs) may be an RNN. Other types of neural networks and combinations may be used. Using a plurality of neural networks in the first layer may provide flexibility in handling input data since different types of neural networks may be used for different types of input data. In addition, when subgroups of input data are handled separately, the number of network parameters may be significantly smaller than the situation in which all input data is fed into a single neural network. Thus, embodiments of the present invention may provide a significant advantage over prior art technology by enabling faster and more efficient network training and forecast calculations.

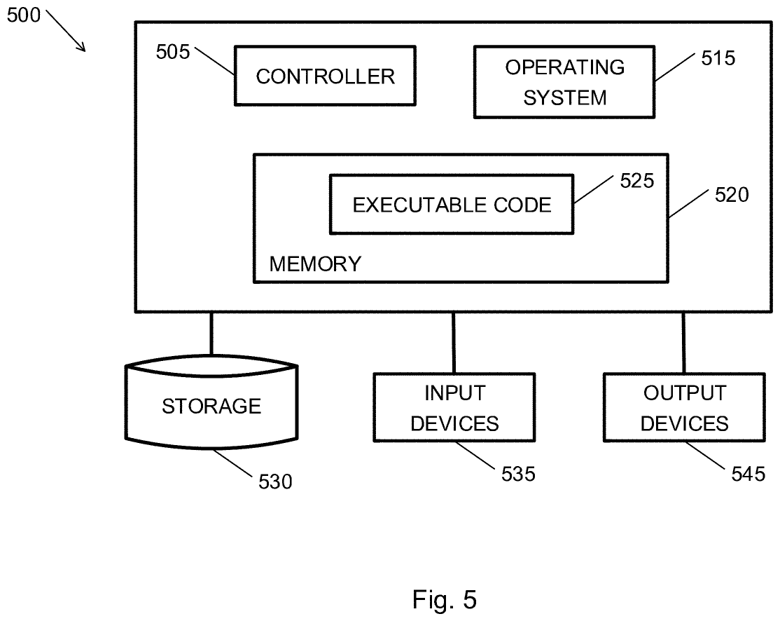

The neural networks or machine learning models discussed herein may include those with “virtual” neurons modeled by data structures executed by processors or computing systems such as the Example shown in FIG. 5. An MLP network may include for example at least three layers of neurons that, except for the input layer, use nonlinear activation functions. A DNN may refer to any neural network with more than one hidden layer. A CNN may refer to a neural network including for example an input layer, an output layer and a plurality of hidden layer including convolutional layers, a rectified linear unit (RELU layer), pooling layers, fully connected layers, and normalization layers. An RNN may include for example loops connecting output to input, hence the output of an RNN may depend not only on the input that is currently fed in, but on the past history of inputs as well. An LSTM network is a type of an RNN that may include a plurality of LSTM units, each including a memory cell, an input gate, an output gate and a forget gate. Other types of networks or machine learning models may be used.

In some embodiments a first layer of the cascade or set of neural networks may extract features and a second layer may obtain the features and determine whether an event is an outlier or normal. While neural networks themselves often include layers of neurons, a layer of a set or cascade of neural networks may include one or more neural networks. Training a cascade of neural networks may be done in an end-to-end manner; thus, embodiments of the invention improve the technology of outlier detection by providing a higher level of optimization since the feature extraction and outlier decision may be optimized together. This is different than extracting features separately in a preliminary step and feeding these features as inputs to a neural network for detecting outliers. Training a neural network involves providing labeled or tagged positive and negative examples to the neural network (e.g., time series data related to or describing normal events and outliers and tagged accordingly); then the neural network algorithms adjusts the neural network parameters (e.g., weights) based on these examples. Thus, if features are extracted in a preliminary step that is separated from the neural network, optimization may not include the feature extraction step. Consequently, the features themselves may not be optimal.

According to embodiments of the invention, a plurality of neural networks may be used as a first layer of the cascade of neural networks, to create feature maps. The feature maps of each neural network may be flattened and combined. For example, the output of each of the neural networks in the first layer may be a vector or a matrix of variables with different dimensions. In order to combine the outputs of the plurality of neural networks in the first layer, matrices may be converted into vectors (e.g., flattened) and the vectors may be combined. The vectors may be for example one-dimensional arrays, or ordered sets. Other methods may be used to combine the outputs of the first layer. The feature maps may be used as input to an outlier detection neural network that may form a second layer of the cascade of neural networks.

In some embodiments, the inputs for the plurality of neural networks may be arranged so that each one of the neural networks of the first layer handles different input types. For example, a first neural network of the first layer may obtain as input features related to or describing payments and payment habits of players and a second neural network of the first layer may obtain as input features related to or describing gaming habits of players such as bets and spins (e.g., virtual spins of an online slot machine).

In some embodiments, the inputs for the plurality of neural networks may be arranged so that each one of the neural networks of the first layer handles different time windows, time periods or time resolutions. For example, a first neural network of the first layer may obtain as input features related to or describing a first time resolution or time window, a second neural network may obtain as inputs features related to a second time resolution or time window, etc. For example, a first neural network of the first layer may obtain as input features in time resolution of days, a second neural network may obtain as inputs features in time resolution of hours, a third neural network may obtain as inputs features in time resolution of minutes, a fourth neural network may obtain as inputs features in time resolution of seconds, a fifth network may obtain the row time series data, and so on as may be required. The feature types may include basic statistics on the row time series data in the selected time resolution, time frame, or time window. For example, the feature types may include mean (average), median, standard deviation, etc., of events (e.g., in the time series data) in a time period, time frame, or time window, a number or count of events in a time period or time window, ratios between events (e.g., average wins to bets) in the time period or time window etc. The size of the time period or time window may be different for each neural network in the first layer. For example, features may include average wins in one day in one neural network, in one hour in a second neural network and in one minute in a third neural network.

Using a plurality of neural networks in the first layer may provide flexibility in handling each time window. For example, different types of neural networks may be used for different time resolutions or time frames of different sizes. For example, daily data may be better handled by a DNN, while real time data, characterized by rare events such as purchase or spin, may be better handled by an RNN or an LSTM network, which are more advanced implementations of neural networks. In addition, feature types may be divided into subgroups and each subgroup is handled by a dedicated neural network, the number of network parameters may be significantly smaller than the situation in which all data is fed into a single neural network. Thus, embodiments of the present invention may provide a significant advantage over prior art technology by enabling faster and more efficient network training and forecast calculations.

Embodiments of the invention may provide a multi-variate analysis of time series data which cannot be performed by a human, humans being limited to three-dimensional perception. In many cases, to efficiently detect outliers there is a need to analyze data in more than three-dimensional space, e.g., each feature type may define a dimension and more than three feature types may be used. For example, feature types may include bets over time (e.g., time series data including bets values of a player) wins over time (e.g., time series data including wins values of a player), average bets in one day, average wins in one day, average bets in one hour, average wins in one hour, average bets in one minute, average wins in one minute, etc. Embodiment of the invention, may find correlations or patterns in huge amount of data which are much behind the human capabilities.

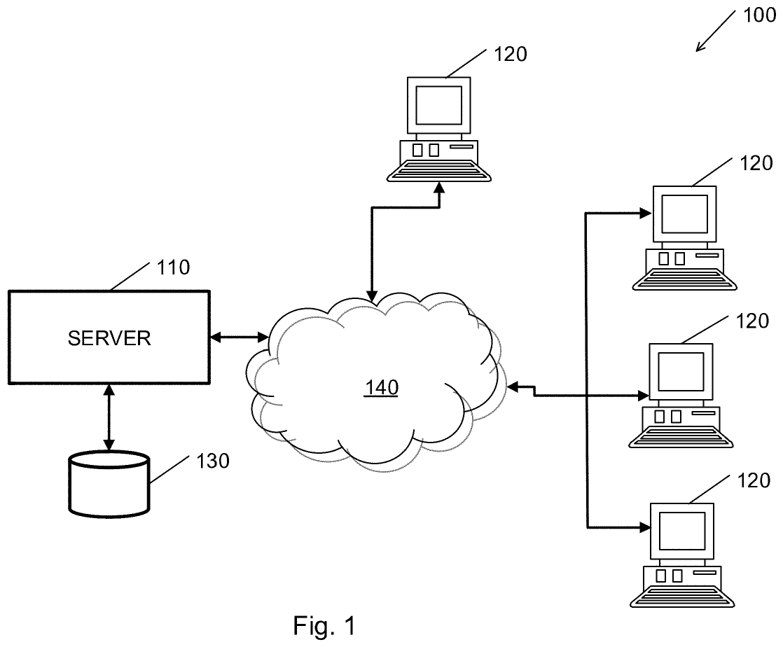

Reference is made to FIG. 1, which schematically illustrates a system 100, according to embodiments of the invention. System 100 may include server 110 to conduct and operate online games between server 110 and user devices 120, or among user devises 120 themselves. Server 100 may be configured to detect, flag or categorize outliers in gaming patterns and analyze the root cause of the outliers, as disclosed herein. Server 110 may be connected to database 130 for storing time series data related to gaming patterns of players, such as spins, purchases, bets wins, etc., over time, and other data such as weights of neural networks, and any other data as may be required. While on-line games are discussed herein, other phenomena or activities may be analyzed according to embodiments of the present invention.

System 100 may be connected, or configured to be connected, to one or more user devices 120, such as, computers, smartphones, gaming consoles, etc., over network 140. Users may use user devices 120 to connect to and play at online games provided by server 110, for example, using or operating user devices 120. Each of user devices 120 and server 110 may be or may include a computing device such as computing device 500 depicted in FIG. 5. Database 130 may be or may include a storage device such as storage device 530.

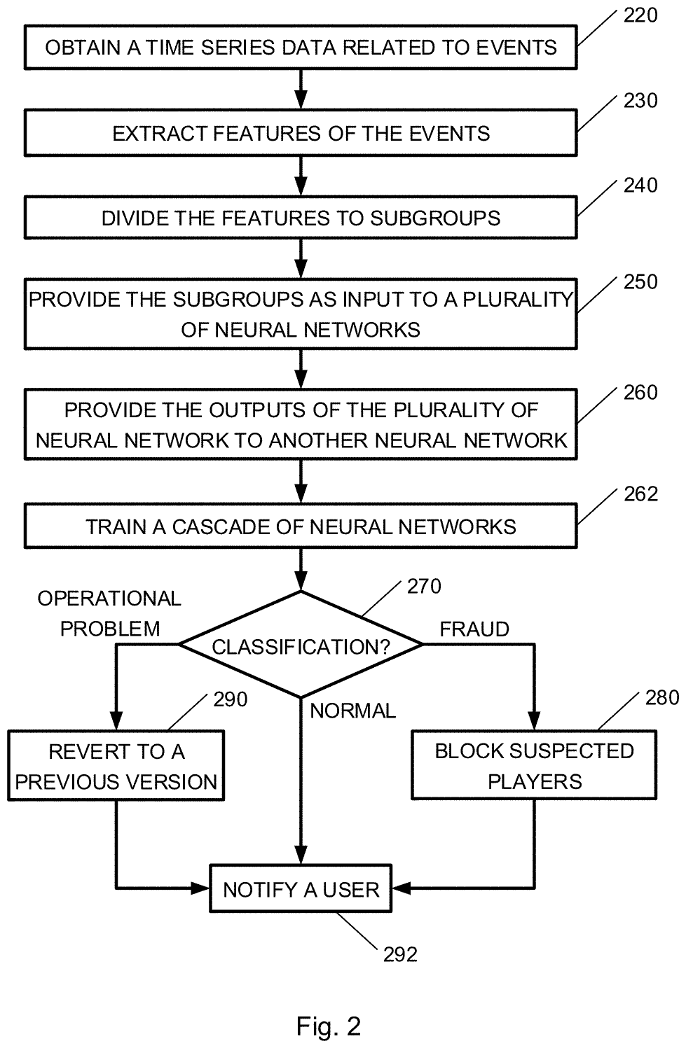

Reference is now made to FIG. 2 which is a flowchart of a method for detecting, flagging or categorizing anomalies or other error conditions in activities or data, such as in gaming patterns, using a cascade of neural networks, according to embodiments of the present invention. An embodiment of a method for detecting anomalies in gaming patterns using a cascade of neural networks may be performed, for example, by server 110 presented in FIG. 1, but other hardware may be used.

In operation 220 time series data related to or describing events, software actions or data, or activities may be obtained. The events, actions, data or activities can be for example those taking place in the real world (e.g. a user providing input), or software (e.g. a computer program taking action or receiving input). In one embodiment the events may include gaming activities of players and/or received outcomes, such as bets and wins log in times, levels, scores, bonus amounts and other gaming related player actions and received outcomes, etc. Other data, not relating to games, may be analyzed.

The time series data may be in the form of a multi-channel time series {xᵢ^{t}} where x indicates an event value (e.g., gaming activities of players, and received outcomes, such as a value of bets and wins), i=1, 2, . . . , n indicates channel number, e.g., an identifier of a single stream of time series data, for example bets over time of a player may be a first channel, wins a second channel etc., and t=1, 2, . . . , m indicate time of sample or sample number. Data may be collected from various data sources such as game databases (e.g., as database 130 presented in FIG. 1) storing the different game related actions and from a client module running on user devises (e.g., user devises 120) which may record actions taken by the player client module and related outcomes. The data may be compiled into a multi-channel time series data format. For example, the various events which may arrive asynchronously from the various databases and user devices, may be arranged according to player ID and sorted by time of occurrence. Thus, the time series data may include, for each player ID, a plurality of channels including event values of a particular event type over time. In addition, raw data may be processed to replace missing values, for example by the mean of similar events. Categorical variables may be formulated, for example by replacing each categorical variable to one or more binary variables. The time series data may be normalized, e.g., using any applicable method such as range scaling, Z score, principal component analysis (PCA), etc. In some embodiments, addresses for various databases (e.g., database 130) for collecting and storing events data such as the Apache Kafka database may be obtained.

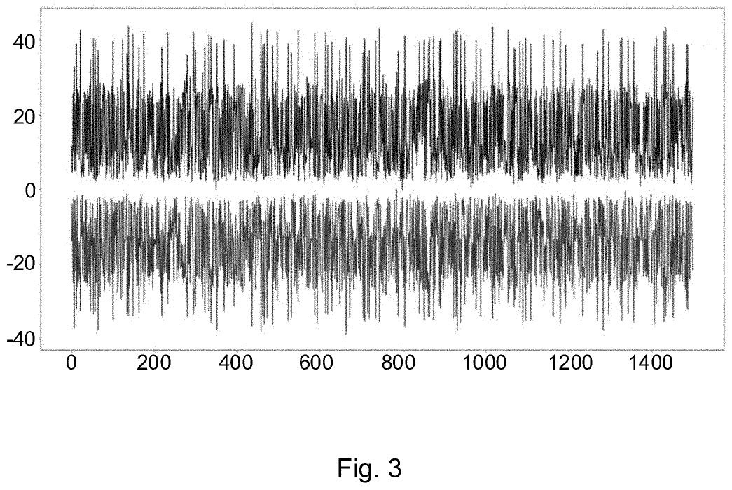

An example of time series data is presented in FIG. 3. FIG. 3 includes time series data of two example channels—the bottom channel is bets and the top channels is wins of a single player. The X-axis is sample number.

In operation 230 features may be extracted from the time series data. Features may include statistics on the time series data in a time window or time period, e.g., average, standard deviation, percentiles, ratios, counts of events, etc. Examples may include average bets in a time period, e.g., one hour, one day, etc., average session length (e.g., game) length in a time period, number of logins in a time period, ratios of the above features, e.g., average bets to average wins ratio, etc.

In operation 240 the extracted features may be arranged in or divided, categorized or segmented into at least two subgroups of features. In some embodiments, features may be divided to subgroups arbitrarily. In some embodiments, features may be divided, categorized or segmented into subgroups according to feature types. For example, a first subgroup may include features related to or describing payments and payments habits of players and a second subgroup may include features related to gaming habits of players such as bets and spins. In some embodiments, features may be divided, categorized or segmented to subgroups according to a time resolution of the features, so that each subgroup of features may include features related to a time window or a time period of a certain length. For example, a first subgroup of features may include features (e.g., statistics on the time series data) calculated for a time window or time period of one day, a second subgroup of features may include features calculated for a time window or time period of one hour, a third subgroup of features may include features calculated for a time window or time period of one minute, and a fourth subgroup may include the raw data. Other numbers of subgroups and durations of time windows may be used.

In operation 250 the subgroups of features may be provided as input to a plurality of neural networks, e.g., each subgroup of features may be provided as input to a dedicated neural network. For example, a first subgroup of features may be provided as input to a first neural network, a second subgroup of features may be provided as input to a second neural network, etc. The neural networks may pertain to a first layer of a cascade of neural networks, whose output may be considered as a “feature map”. The neural networks in the first layer may be of the same type or of different types of neural networks. In some embodiments, the type of neural network may be fitted to the type of data or features. For example, different types of neural networks may be used for different time windows. For example, features calculated for a time window or time period of one or more days may be provided as input to a DNN, while real time data, characterized by rare events, may be provided as input to a RNN or LSTM network.

In block 260 the output of the plurality of neural networks of the first layer may be provided as input to an outlier detection neural network that may be considered as a second layer. The neural networks of the first layer and the neural network of the second layer may form a cascade of neural networks. The cascade of neural networks may include more than two layers, in which case the output of each layer may be provided as an input to a next layer up to the last layer.

In operation 262 the cascade of neural networks may be trained to detect, flag, or categorize anomalies, faults or error conditions in the time series data. The anomalies, faults or error conditions may include software or hardware malfunctions or breakdowns, human mistakes, or intentionally damaging, illegal or fraudulent human events. For example, anomalies may include cases of fraud or operational problems. Thus, the cascade of neural networks may be trained to categorize the time series data into normal behavior, fraud or operational problem. Depending on the training date set, the cascade of neural networks may be trained to categorize the time series data into normal behavior or to a plurality of fraud types and a plurality of operational problems. It is noted that the networks may be trained as a group, rather than individually, to detect or categorize such information in some embodiments, the cascade of neural networks may be trained using backpropagation where the input of the second layer of neural networks may be propagated as the desired output or the first layer of neural networks. For example, the cascade of neural networks may be trained using one loss function on the output of the last neural network (e.g., the outlier detection neural network) which is then backpropagated to adjust the weights of all the neural networks of the cascade of neural networks.

The cascade of neural networks may include two or more layers of neural networks, a first layer that is configured to obtain the time series data or features extracted from the time series data as inputs and to provide feature maps as output, and a last layer of a single neural network that is configured to obtain the feature maps as inputs and to provide categorization of the time series data as output. The cascade may include intermediate layers of neural network as needed. According to embodiments of the invention, the entire cascade of neural networks, including the neural networks of the first layer and the neural network of the second layer, may be trained together, as a single unit. Training the entire cascade of neural networks together may provide a higher level of optimization compering to training a system to extract features (or extracting features manually) and training a system to use these features for classification. The higher level of optimization may be achieved since features are optimized for the classification task according to examples and not according to some heuristic that a human developer may create which may suffer from sub optimality.

As known, training of neural networks, including the cascade of neural networks, includes providing labeled or tagged training sets to the neural network. The labeled or tagged training sets may include data (e.g., time series data and features extracted therefrom) that is marked by an operator (e.g., a human operator) as related to normal behavior, fraud (or a specific type of fraud) or operations problem (or a specific type of operational problem). One of the main issues that should be considered when generating a training set is the significant imbalance population ratio between the normal population, which is the majority of the population, and the outliers (e.g., the anomalies, fraud and operational problems) which the cascade of neural networks should detect. Several approaches can be taken to solve this problem, e.g. change the network loss function to be cost sensitive allowing an outlier error cost to be much more significant than normal population error. Another approach is to sample more labeled training sets from the outlier population in each batch. Synthetically adding more outliers to the training set is another well-known approach. In any case, the network may be configured to detect the types of outliers that are provided in the labeled training sets. In some embodiments, the cascade of neural networks may be trained using unsupervised data to extract normal data behavior and the cascade of neural networks may detect data which behaves differently, e.g., anomalies.

As indicated in block 270 the multi-layer neural network may provide a classification of the time series data to fraud (or a specific type of fraud), operational problem (or a specific type of operational problem) or normal behavior. The cascade of neural networks may be pre-trained together as a single unit to detect anomalies in the time series data. Thus, the cascade of neural networks may categorize the time series data into normal behavior, fraud or operational problem. Depending on the training of the multi-layer neural network, the cascade of neural networks may categorize the time series data into normal behavior or to a plurality of fraud types and a plurality of operational problems.

In case the time series data is classified as representing fraud, then suspected players may be temporarily or permanently blocked, as indicated in operation 280. For example, players that are associated with events that have been classified fraud may be temporarily or permanently blocked. In case the time series data is classified as representing an operational problem, then as indicated in operation 290, the system may take an action automatically, depending on the type of operational problem detected. For example, the system may revert to a last known stable version of the software, disconnect one or more servers (such as serves 110), etc. In operation 292, a user or a human operator may be notified about the classification of the time series data as representing normal behavior, fraud or operational problem. Notification may be provided as a report including the time and type of problem detected, and any other relevant data, and/or as an alarm in case of fraud or operational problem.

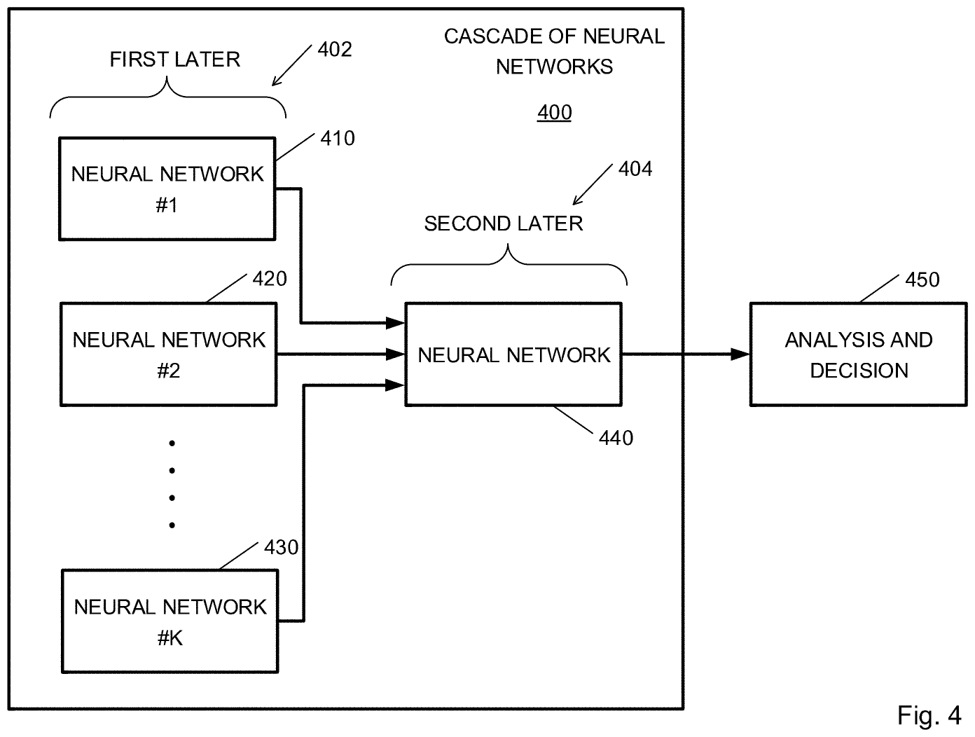

Reference is made to FIG. 4, showing a block diagram of a cascade of neural networks 400 according to some embodiments of the present invention. Cascade of neural networks 400 may include a first layer 402 of neural networks 410, 420 and 430 (also referred to herein as dedicated neural networks) and a second layer 404 of neural network 440 (also referred to herein as outlier detection neural network). Each of neural networks 410, 420, 430 and 440, and analysis and decision block 450 may be executed by processors or computing systems such as the Example shown in FIG. 5.

Each of neural networks 410, 420 and 430 may obtain as input the time series data or features extracted from the time series data, as disclosed herein. Each of neural networks 410, 420 and 430 may generate feature maps as outputs, which may be provided as input to neural network 440 which may form the second layer 404 of cascade of neural networks 400. As disclosed herein, cascade of neural networks 400 may be trained using labeled or tagged sets of time series data and may be configured to provide classification of time series data related to gaming patterns and activities of players.

In some embodiments analysis and decision block 450 may obtain the results of neural network 440, e.g., the classification of the time series data and may perform an action based on the classification based on business rules. For example, in case the time series data is classified as representing fraud, then suspected players may be blocked. In case the time series data is classified as representing an operational problem, then the system may take an action automatically, depending on the type of operational problem detected, as disclosed herein. In addition, a notification may be generated about the classification of the time series data as representing normal behavior, fraud or operational problem. Notification may be provided as a report including the time and type of problem detected, and any other relevant data, and/or as an alarm in case of fraud or operational problem.

Reference is made to FIG. 5, showing a high-level block diagram of an exemplary computing device according to some embodiments of the present invention. Computing device 500 may include a processor or controller 505 that may be, for example, a central processing unit processor (CPU), a graphics processing unit (GPU), a chip or any suitable computing or computational device, an operating system 515, a memory 520, executable code 525, storage or storage device 530, input devices 535 and output devices 545. Controller 505 may be configured to carry out methods described herein, and/or to execute or act as the various modules, units, etc., for example by executing code or software. More than one computing device 500 may be included. Multiple processes discussed herein may be executed on the same controller. For example, server 110 presented in FIG. 1 and neural networks 410, 420, 430 and 440 and analysis and decision block 450 depicted in FIG. 4 may be implemented by one or more controllers 505.

Operating system 515 may be or may include any code segment (e.g., one similar to executable code 525 described herein) designed and/or configured to perform tasks involving coordination, scheduling, arbitration, supervising, controlling or otherwise managing operation of computing device 500, for example, scheduling execution of software programs or enabling software programs or other modules or units to communicate. Operating system 515 may be a commercial operating system.

Memory 520 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 520 may be or may include a plurality of, possibly different memory units. Memory 520 may be a computer or processor non-transitory readable medium, or a computer non-transitory storage medium, e.g., a RAM.

Executable code 525 may be any executable code, e.g., an application, a program, a process, task or script. Executable code 525 may be executed by controller 505 possibly under control of operating system 515. For example, executable code 525 may be an application that when executed operates or trains neural networks, processes time-series data, detects anomalies in systems such as gaming patterns, etc. as described herein. Although, for the sake of clarity, a single item of executable code 525 is shown in FIG. 5, a system according to embodiments of the invention may include a plurality of executable code segments similar to executable code 525 that may be loaded into memory 520 and cause controller 505 to carry out methods described herein. For example, units or modules described herein may be, or may include, controller 505 and executable code 525.

Storage device 530 may be any applicable storage system, e.g., a disk or a virtual disk used by a VM. Storage 530 may be or may include, for example, a hard disk drive, a floppy disk drive, a Compact Disk (CD) drive, a CD-Recordable (CD-R) drive, a Blu-ray disk (BD), a universal serial bus (USB) device or other suitable removable and/or fixed storage unit. Content or data may be stored in storage 530 and may be loaded from storage 530 into memory 520 where it may be processed by controller 505. In some embodiments, some of the components shown in FIG. 5 may be omitted. For example, memory 520 may be a non-volatile memory having the storage capacity of storage 530. Accordingly, although shown as a separate component, storage 530 may be embedded or included in memory 520.

Input devices 535 may be or may include a mouse, a keyboard, a touch screen or pad or any suitable input device. It will be recognized that any suitable number of input devices may be operatively connected to computing device 500 as shown by block 535. Output devices 545 may include one or more displays or monitors, speakers and/or any other suitable output devices. It will be recognized that any suitable number of output devices may be operatively connected to computing device 500 as shown by block 545. Any applicable input/output (I/O) devices may be connected to computing device 500 as shown by input devices 535 and output devices 545. For example, a wired or wireless network interface card (NIC), a printer, a universal serial bus (USB) device or external hard drive may be included in input devices 535 and/or output devices 545.

Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 520, computer-executable instructions such as executable code 525 and a controller such as controller 505.

The storage medium may include, but is not limited to, any type of disk including, semiconductor devices such as read-only memories (ROMs) and/or random access memories (RAMS), flash memories, electrically erasable programmable read-only memories (EEPROMs) or any type of media suitable for storing electronic instructions, including programmable storage devices. For example, in some embodiments, memory 520 is a non-transitory machine-readable medium.

A system according to some embodiments of the invention may include components such as, but not limited to, a plurality of central processing units (CPU) or any other suitable multi-purpose or specific processors or controllers (e.g., controllers similar to controller 505), a plurality of input units, a plurality of output units, a plurality of memory units, and a plurality of storage units. A system according to some embodiments of the invention may additionally include other suitable hardware components and/or software components. In some embodiments, a system may include or may be, for example, a personal computer, a desktop computer, a laptop computer, a workstation, a server computer, a network device, or any other suitable computing device. For example, a system according to some embodiments of the invention as described herein may include one or more devices such as computing device 500.

Different embodiments are disclosed herein. Features of certain embodiments may be combined with features of other embodiments; thus certain embodiments may be combinations of features of multiple embodiments.

Embodiments of the invention may include an article such as a computer or processor readable non-transitory storage medium, such as for example a memory, a disk drive, or a USB flash memory device encoding, including or storing instructions, e.g., computer-executable instructions, which when executed by a processor or controller, cause the processor or controller to carry out methods disclosed herein.

While the invention has been described with respect to a limited number of embodiments, these should not be construed as limitations on the scope of the invention, but rather as exemplifications of some of the preferred embodiments. Other possible variations, modifications, and applications are also within the scope of the invention. Different embodiments are disclosed herein. Features of certain embodiments may be combined with features of other embodiments; thus, certain embodiments may be combinations of features of multiple embodiments.

What is claimed is:

1. A method for detecting anomalies in time series data, the method comprising:
obtaining the time series data, wherein the time series data is related to events;
extracting features from the time series data;
dividing the features into at least two subgroups of features;
providing each of the subgroup of features as input to a neural network of a plurality of neural networks of a first layer of neural networks; and
providing outputs of each of the neural networks of the first layer as input to an outlier detection neural network,
wherein the neural networks of the first layer and the outlier detection neural network are trained to detect the anomalies in the time series data, and wherein the outlier detection neural network provides a classification of the time series data.

2. The method of claim 1, wherein the features are divided based on a type of the features.

3. The method of claim 1, wherein the features are divided based on a time window of the features.

4. The method of claim 1, comprising:
providing real time data as input to a first dedicated neural network of the plurality of dedicated neural networks;
providing features related to a time window of 1-2 days as input to a second dedicated neural network of the plurality of dedicated neural networks; and
providing features related to a time window of 1-2 hours as input to a second dedicated neural network of the plurality of dedicated neural networks.

5. The method of claim 4, wherein the first dedicated neural network is a deep neural network and the second and third dedicated neural networks are one of a recurrent neural network and a long-short term memory network.

6. The method of claim 1, wherein the time series data is related to events in online games.

7. The method of claim 1, wherein the outlier detection neural network provides a classification of the time series data to one of fraud, operational problem and normal behavior, and wherein the method further comprises reverting to a last known stable version of the software in case the classification is fraud.

8. A system for detecting anomalies in time series data of online games, the system comprising:
a memory; and
a processor configured to:
obtain the time series data, wherein the time series data is related to events in online games;
extract features from the time series data;
divide the features into at least two subgroups of features;
provide each of the subgroup of features as input to a dedicated neural network of a plurality of dedicated neural networks; and
provide outputs of each of the dedicated neural networks as input to an outlier detection neural network,
wherein the dedicated neural network and the outlier detection neural network are trained to detect the anomalies in the time series data.

9. The system of claim 8, wherein the processor is configured to divide the features based on a type of the features.

10. The system of claim 8, wherein the processor is configured to divide the features based on a time window of the features.

11. The system of claim 8, wherein the processor is configured to:
provide real time data as input to a first dedicated neural network of the plurality of dedicated neural networks;
provide features related to a time window of 1-2 days as input to a second dedicated neural network of the plurality of dedicated neural networks; and
provide features related to a time window of 1-2 hours as input to a second dedicated neural network of the plurality of dedicated neural networks.

12. The system of claim 11, wherein the first dedicated neural network is a deep neural network and the second and third dedicated neural networks are one of a recurrent neural network and a long-short term memory network.

13. The system of claim 8, wherein the processor is configured to train the dedicated neural network and the outlier detection neural network to detect the anomalies in the time series data using a labeled training set.

14. The system of claim 8, wherein the outlier detection neural network provides a classification of the time series data to one of fraud, operational problem and normal behavior, and wherein the processor is configured to revert to a last known stable version of the software in case the classification is fraud.

15. A method for detecting anomalies in time series data of online games, the method comprising:
segmenting features describing time series data related to events into subgroups of features;
inputting a first subgroup of features to a first neural network;
inputting a second subgroup of features to a second neural network,
providing output of the first neural network and output of the second neural network as input to a third neural network,
wherein the first neural network, the second neural network and the third neural network are trained to detect anomalies in the time series data.

16. The method of claim 15, wherein the first subgroup of features relates to a first type of features and the second subgroup of features relates to a second type of features.

17. The method of claim 15, the first subgroup of features relates to a first time window and the second subgroup of features relates to a second time window.

18. The method of claim 15, comprising:
providing real time data as input to a third neural network;
providing output of the third neural network as input to a third neural network;
wherein the third neural network is trained together with the first neural network, the second neural network and the third neural network,
wherein the first time window is of 1-2 days, the second time window is of 1-2 hours.

19. The method of claim 18, wherein the first neural network is a deep neural network and the second neural network is one of a recurrent neural network and a long-short term memory network.

20. The method of claim 19, comprising training the first neural network, the second neural network and the third neural network together using a labeled training set.
